(19) United States
(12) Patent Application Publication
(10) Pub. No.: US 2008/0289761 A1
(43) Pub. Date: Nov. 27, 2008

(54) Polyurethane Composition with High Early Strength

(76) Inventors: Bernhard Bosshard, Remetschwil (CH); Michael Schlumpf, Stallikon (CH)

Correspondence Address: BINGHAM MCCUTCHEN LLP, Three Embarcadero Center, San Francisco, CA, 94111-4067, US

(21) Appl. No.: 11/579,997

(22) PCT Filed: May 10, 2005
(86) PCT No.: PCT/EP05/52096

§ 371 Date: Feb. 26, 2008

(30) Foreign Application Priority Data
May 10, 2004 (EP) 04102004.1

(51) Int. Cl. C09J 175/06; C08G 18/16

(52) U.S. Cl. 156/331.4; 524/590

(57) ABSTRACT

Polyurethane compositions are disclosed which are particularly suitable as adhesives, show excellent solidity build-up throughout the −10° C.-35° C. temperature range and are easy to apply. In particular, adhesives showing an excellent crash performance can be formulated within the context of the present invention.

### TECHNICAL FIELD

The invention relates to polyurethane compositions which are also suitable for low-temperature applications and which possess a high green strength. In particular the invention relates to adhesives for the bonding of automotive windows.

### PRIOR ART

Polyurethane adhesives have been used for a long time in automobile and vehicle construction. Adhesives of this kind are employed inter alia for the bonding of glass systems, and represent one-component moisture-curing polyurethane adhesives. The glass systems are either employed during vehicle construction on the line or else by garages or window replacement companies in the event of repairing a defective glass system. Especially in less densely populated areas, a vehicle window has to be replaced on the street, and consequently the ambient temperature is an important factor affecting the use of a window adhesive for a successful window repair. These one-component moisture-curing polyurethane adhesives have very long cure times, typically extending to days, which are also dependent on climatic conditions.

With the increase of airbags as protective installations for the occupants, a new problem arose in connection with the adhesive bonding of automotive windows. Since in the event of an impact an airbag inflates at high speed and force and, in so doing, supports itself against the window in order to protect the occupants, the adhesive bond has become a safety-relevant component of the vehicle, and the bonding of a repaired window must have developed sufficient strength, when the vehicle goes into commission again, to withstand without damage the forces of a triggered airbag and the impulse of the vehicle occupants in the event of a vehicle crash thereby maintaining the protective function of the airbag.

In order to realize window adhesives which have such crash-resistant properties, therefore, a rapid development of strength is extremely important. Rapid development of strength may take place chemically or physically. A chemically accomplished rapid development of strength can be achieved by means of 2-component adhesives, with the two components reacting rapidly with one another and the vehicle being ready to drive again after just a short time. However, the application of such two-component systems, such as 2 K [2-component] PU, is very complex, inconvenient to the customer, and occasionally critical in respect of mixing errors. A way around these difficulties is offered, it is true, by the thermosetting 1-component adhesives, in which the effect of temperature releases a catalyst or in which the effect of temperature causes blocked compounds which are inert beforehand to release substances which allow the crosslinking of reactive components. However, this means that the adhesive must be heated. In order for an adhesive of this kind to be storable even at warm temperatures, such thermosetting must take place at relatively high temperatures. This necessity, however, means that adhesives of this cannot be applied to cold or heat-sensitive substrates and that, as a result, there is a massive increase in the risk of failure of the adhesive bond.

The principle of the physical development of strength is realized in, for example, hotmelt adhesives. These adhesives are composed primarily of a melt component, which melts at the application temperature, is applied to the substrate and, on cooling, solidifies again. The melting-cooling operation is a reversible process. In order to prevent an adhesive bond being lost owing to melting of the adhesive at a relatively high ambient temperature, the melting temperature in hotmelt adhesives is typically chosen at a high level. This high melting temperature, however, leads to the disadvantage, here again, that a hotmelt cannot be employed on cold substrates, since the adhesive cools more rapidly than the adhesion can be built up. Apart from the fact that hotmelt adhesives are poorly suited to the adhesive bonding of heat-sensitive substrates, a great disadvantage is that these adhesives require a heating operation with appropriate equipment, and undergo creep owing to their plastic character under long-term loads.

Reactive hotmelt adhesives combine physical and chemical curing. Reactive hotmelt adhesives of this kind are known and are typically composed of a melt component containing reactive groups, isocyanate groups for example. For the purpose of application it is necessary to melt this adhesive, which is typically done at temperatures above 60° C. Following application, these adhesives cool, as a result of which the adhesives undergo solidification and subsequent post-crosslinking with atmospheric humidity. Adhesives of this kind are known from EP 0 705 290, for example. A disadvantage with this kind, however, is that the adhesive has to be heated, since this kind of adhesive cannot be applied below the liquefaction temperature. Moreover, there are no known reactive hotmelt adhesives which develop strength sufficiently rapidly in the temperature range between −10° C. and 35° C. to withstand a crash.

### DISCLOSURE OF THE INVENTION

It was an object of the present invention to provide a polyurethane composition which makes it possible to design adhesive bonds which both at low and at high temperatures simultaneously exhibit a sufficiently rapid development of strength and on the other hand also have good application properties.

Surprisingly it has been found that this is possible with the polyurethane composition of claim 1 according to the invention.

The polyurethane composition of the invention is outstandingly suitable as an adhesive. Such adhesives are notable in particular for a combination of a rapid development of strength and good application properties at both low and high temperatures. This effect is particularly important in the temperature window between −10 and 35° C., in particular between 5 and 35° C. This is achieved by means of an adhesive which within this temperature range is distinguished by a comparably low viscosity rise and also has a high reactivity at low temperatures and a reactivity which is not too rapid at high temperatures. The polyurethane composition of the invention needs no admixing of a second component in order to achieve a rapid development of strength.

Advantageous embodiments of the invention have the advantage that the polyurethane composition can be applied without prior heating and that drive-away times which are independent of climatic conditions are realized in the climatic window from −10° C. to 35° C. This is particularly favorable in those cases where the composition is used for a repair.

Further advantageous embodiments of the invention are apparent from the subclaims.

### WAYS OF PERFORMING THE INVENTION

The present invention relates to polyurethane compositions which comprise at least one polyurethane prepolymer A, at least one catalyst B1 and at least one catalyst B2, carbon black, at least one compound C of the formula (I) and also, optionally, a polyurethane prepolymer D, optionally a polyurethane prepolymer E, optionally a polyurethane prepolymer F, optionally an aliphatic polyisocyanate G, and optionally a pyrogenic silica.

The prefix “poly” in “polyol” and “polyisocyanate” means throughout the present document that in each case there are two or more of the respective functional group present in the molecule.

The polyurethane composition further comprises at least one polyurethane prepolymer A. The polyurethane prepolymer A contains isocyanate end groups and is prepared from at least one aromatic polyisocyanate and at least one polyoxyalkylene polyol A1.

The polyurethane composition further comprises at least one catalyst B1 and one catalyst B2. The catalyst B1 contains at least one tertiary amine group. In particular the catalyst B1 is 1,4-diazabicyclo-[2.2.2]octane (DABCO) and a dimorpholino ether. Particular preference is given to dimorpholino ethers, especially dimorpholino ethers as described by the formula on page 3 lines 1 to 18 in EP 0 812 866 A1, and 2,2′-dimorpholinodiethyl ether (DMDEE). Particular preference is given to 2,2′-dimorpholinodiethyl ether.

In addition the polyurethane composition comprises at least one catalyst B2. The catalyst B2 is a tin catalyst; in other words, this catalyst comprises tin. In particular the tin catalyst B2 is selected from the group of tin compounds comprising dibutyltin diacetate, dibutyltin dilaurate, dioctyltin dicarboxylate, dibutyltin dichloride or mixtures thereof.

With preference the tin catalyst B2 is dibutyltin diacetate or dibutyltin dilaurate (DBTL).

The weight ratio of B1/B2 is typically between 30/70 to 99/1, in particular between 50/50 to 99/1, preferably between 55/45 to 98/2, in particular between 55/45 to 90/10.

For the essence of the invention this catalyst combination B1/B2 is important, since it has been shown that with such a combination it is possible to achieve the desired low-temperature reactivity without the system being so rapid at a high temperature that the system can no longer be applied within the typical application window of approximately 5 minutes and the two parts joined.

The polyurethane composition further comprises 5% to 40%, especially 5% to 30%, by weight of carbon black, based on the weight of the polyurethane composition. Within polyurethane chemistry, carbon black is a very well-known constituent of adhesives. With preference the particle size of the carbon black is as small as possible.

The polyurethane composition further comprises at least one compound C of the formula (I)

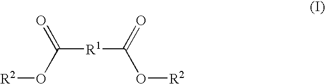

R¹ in this formula is a C₃ to C₈ alkylene group. With particular preference R¹ is a propylene, butylene, heptylene or octylene group.

R² is a C₇ to C₁₃ alkyl group. These alkyl groups can be branched or unbranched, but are preferably unbranched.

With preference this alkyl group is a C₇, C₈ or C₉ alkyl group, in particular a C₈ alkyl group.

The two radicals R² in the formula are preferably identical. With preference the compound C is a dialkyl adipate, especially dioctyl adipate (DOA).

In one preferred embodiment the polyurethane composition further comprises at least one compound C′ of the formula (I′)

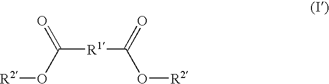

R^{1′} in this formula is an optionally substituted phenylene group.

R^{2′} is a C₇ to C₁₃ alkyl group. These alkyl groups can be branched or unbranched, but are preferably branched. With preference this alkyl group is a C₉ or a C₁₀ alkyl group, in particular an isononyl or isodecyl group.

The two radicals R^{2′} in the formula are preferably identical. With preference the compound C′ is a dialkyl phthalate, especially diisodecyl phthalate (DIDP).

With particular preference the polyurethane composition comprises dioctyl adipate as compound C and diisodecyl phthalate as compound C′.

The polyurethane composition further comprises, optionally, a polyurethane prepolymer D. The polyurethane prepolymer D contains isocyanate end groups and is prepared from at least one polyisocyanate and at least one polyester polyol. The amount of polyurethane prepolymer D, based on the weight of the polyurethane composition, is 0% to 4%, in particular 1% to 4% by weight.

The polyurethane composition further comprises, optionally, a polyurethane prepolymer E. The polyurethane prepolymer E contains isocyanate end groups and is prepared from at least one polyisocyanate and at least one polycarbonate polyol. The amount of polyurethane prepolymer E, based on the weight of the polyurethane composition, is 0% to 20%, in particular 1% to 15% by weight.

The polyurethane composition further comprises, optionally, a polyurethane prepolymer F. The polyurethane prepolymer F contains isocyanate end groups and is prepared from at least one aliphatic polyisocyanate and at least one polyoxyalkylene polyol F1. The amount of polyurethane prepolymer F, based on the weight of the polyurethane composition, is 0% to 15%, in particular 1% to 10% by weight.

The polyurethane composition further comprises, optionally, an aliphatic polyisocyanate G. The aliphatic polyisocyanate G is an aliphatic isocyanurate bearing NCO groups and/or an aliphatic biuret bearing NCO groups. With preference the polyisocyanate G is an isophorone diisocyanate (IPDI) isocyanurate and/or a hexamethylene 1,6-diisocyanate (HDI) biuret. Particular preference in the polyurethane composition is given to a mixture of an IPDI isocyanurate and an HDI biuret. The amount of polyisocyanate G, based on the weight of the polyurethane composition, is 0% to 4%, in particular 0.2% to 2.5%, by weight.

In the course of the preparation of the polyurethane prepolymers A, D, E, and F the polyol and the polyisocyanate are reacted using customary methods, at temperatures for example of 50° C. to 100° C., where appropriate with the accompanying use of suitable catalysts, the polyisocyanate being metered such that its isocyanate groups are present in a stoichiometric excess in relation to the hydroxyl groups of the polyol. The excess of polyisocyanate is chosen such that in the resulting polyurethane prepolymer, after the reaction of all the hydroxyl groups of the polyol, the amount of remaining free isocyanate groups is 0.1% to 15%, preferably 0.5% to 5%, by weight based on the overall polyurethane prepolymer. Optionally the polyurethane prepolymer can be prepared using solvents or plasticizers, the solvents or plasticizers used containing no isocyanate-reactive groups.

The polyisocyanate for preparing the polyurethane prepolymer A is an aromatic polyisocyanate. The polyisocyanate for preparing the polyurethane prepolymer D, where present, and the polyurethane prepolymer E, where present, may likewise be an aromatic polyisocyanate.

The use of aromatic polyisocyanate in the preparation of the polyurethane prepolymer A is very important in order to ensure a high reactivity.

Depending in each case on the polyisocyanates for the use of other polyurethane prepolymers present, the aromatic polyisocyanate is preferably selected from the group comprising tolylene 2,4- and 2,6-diisocyanate (TDI) and any desired mixtures of these isomers, diphenylmethane 4,4′-diisocyanate (MDI) and mixtures thereof, and also all of their isomers and oligomers.

The polyisocyanate for preparing the polyurethane prepolymer F is an aliphatic polyisocyanate. The polyisocyanate for preparing the polyurethane prepolymer D, where present, and the polyurethane prepolymer E, where present, may likewise be an aliphatic polyisocyanate.

Depending in each case on the polyisocyanates for the use of other polyurethane prepolymers present, the aliphatic polyisocyanate is preferably selected from the group comprising hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and 1,4-diisocyanate and any desired mixtures of these isomers, 1-isocyanato-3,3,5-trimethyl-5-isocyanatomethylcyclohexane (i.e., isophorone diisocyanate or IPDI), perhydrodiphenylmethane 2,4′- and 4,4′-diisocyanate (HMDI), 1,4-diisocyanato-2,2,6-trimethylcyclohexane (TMCDI), and also oligomers and polymers of the aforementioned isocyanates, and also any desired mixtures of the aforementioned isocyanates.

The polyurethane prepolymers A, D, E, and F are prepared using polyols. In particular, diols and triols are used.

For the polyurethane prepolymers D polyester polyols are used. Suitable polyester polyols are for example prepared from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforementioned acids, and also polyester polyols formed from lactones such as ε-caprolactone, for example.

Polyester polyols which have been found particularly suitable are those prepared from a diol, in particular an alkylenediol, preferably hexanediol, and a dicarboxylic acid, especially adipic acid, and also polyester polyols prepared from lactones, especially caprolactones, preferably ε-caprolactone, and also mixtures thereof.

For the polyurethane prepolymers E polycarbonate polyols are used. Such polycarbonate polyols are typically prepared from the above-described alcohols—those used to synthesize the polyester polyols—and dialkyl carbonates, diaryl carbonates or phosgene. Polycarbonate polyols which have been found particularly suitable are those preparable from dialkyl carbonates, especially dimethyl carbonate and alkylenediols, especially 1,6-hexanediol.

The polyurethane prepolymers A and F are prepared using polyoxyalkylene polyols A1 and F1.

Polyoxyalkylene polyols are also called polyether polyols by the skilled worker and are polymerization products of ethylene oxide, 1,2-propylene oxide, 1,2- or 2,3-butylene oxide, tetrahydrofuran or mixtures thereof, and are polymerized eventually with the aid of a starter molecule having two or more active hydrogen atoms, such as, for example, water, ammonia or compounds having two or more OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bis-phenol A, 1,1,1-trimethylolethane, 1,1,1-trimethylol-propane, glycerol, aniline, and mixtures of the aforementioned compounds. Use may be made not only of polyoxyalkylene polyols which have a low degree of unsaturation (measured in accordance with ASTM D-2849-69 and expressed in milliequivalents of unsaturation per gram of polyol (meq/g)), prepared for example by means of what are called double metal cyanide complex catalysts (DMC catalysts), but also of polyoxyalkylene polyols having a higher degree of unsaturation, prepared for example with the aid of anionic catalysts such as NaOH, KOH or alkali metal alkoxides.

Particular suitability is possessed by polyoxyalkylene diols or polyoxyalkylene triols.

Especially suitable are polyoxyalkylene diols or polyoxyalkylene triols having a degree of unsaturation lower than 0.02 meq/g and having a molecular weight in the range from 1000 to 30 000 g/mol, and also polyoxypropylene diols and triols having a molecular weight of 400 to 8000 g/mol. By “molecular weight” or “molar weight” is meant in the present document always the molecular weight average Mₙ.

Likewise particularly suitable are what are called EO-end capped (ethylene oxide-end capped) polyoxypropylene diols or triols. The latter are special polyoxypropylene-polyoxyethylene polyols which are obtained, for example, by alkoxylating straight polyoxypropylene polyols, after the polypropoxylation, with ethylene oxide, and which as a result contain primary hydroxyl groups.

The polyoxyalkylene polyols A1 and F1 may be alike or different from one another. Preferably the polyoxyalkylene polyols A1 and F1 are different from one another.

With preference the polyoxyalkylene polyol A1 and where appropriate the polyoxyalkylene polyol F1 is a polyoxyethylene polyol or a poly(oxyethylene/-oxypropylene) polyol, in particular polyethylene glycol. In the case of the poly(oxyethylene/-oxypropylene) polyol the EO/PO ratio, in other words the ratio of the ethylene oxide (EO) units to propylene oxide(PO) units, is in particular more than 10 mol/90 mol, preferably between 10 mol/90 mol and 35 mol/65 mol.

In one preferred embodiment A1 is a polyoxyalkylene triol, in particular an EO/PO triol.

In one preferred embodiment F1 is a polyoxypropylene polyol, in particular a polyoxypropylene diol.

The polyurethane composition further comprises, optionally, pyrogenic silica. The amount of pyrogenic silica, based on the weight of the polyurethane composition, is 0% to 4%, in particular 0.5% to 3%, by weight. There are different suitable commercially available pyrogenic silicas, under the name AEROSIL® from Degussa or WACKER HDK® from Wacker Chemie GmbH, for example.

Finally, the polyurethane composition may further comprise other constituents, such as solvents; organic and inorganic fillers, such as, for example, ground or precipitated calcium carbonates, which may have been coated with stearates, or else kaolins, aluminum oxides, and PVC powders; fibers, of polyethylene for example; pigments; rheology modifiers such as thickeners, examples being urea compounds, polyamide waxes or bentonites, adhesion promoters, especially silanes such as epoxy silanes, vinyl silanes, isocyanatosilanes, and aminosilanes reacted with aldehydes to form aldiminosilanes; driers such as p-tosyl isocyanate and other reactive isocyanates, orthoformic esters, calcium oxide or molecular sieves, for example; stabilizers with respect to heat, light and UV radiation; flame retardants; surface-active substances such as wetting agents, flow control agents, devolatilizers or defoamers, for example; fungicides or substances which inhibit fungal growth; and also further substances typically used in the polyurethane industry.

The polyurethane composition cures with water, in particular in the form of atmospheric humidity. Consequently, the polyurethane composition is employed preferably as a moisture-curing one-component composition. It is, however, entirely conceivable for the composition to form a two-component composition with a curing agent comprising a compound which is reactive with isocyanate, especially polyamine or polyol. Formulation as a two-component composition would have the advantage that curing would take place more rapidly.

The polyurethane composition is employed in particular as an adhesive or sealant, in particular as a window adhesive.

In this context the polyurethane composition is applied to the surface of the first substrate, after which the polyurethane composition is contacted with a surface of a second substrate, and then the polyurethane composition is cured.

The first and/or second substrate is preferably made of a material selected from the group comprising glass, glass ceramic, paint, steel, aluminum, polycarbonate, ABS, GRP, and polypropylene. With particular preference the substrate is a vehicle window, in particular an automotive window. The other substrate is preferably a paint, in particular a painted metal panel, preferably a painted flange. The polyurethane composition is applied typically to an automotive window, in the form of a bead, after which the automotive window together with the applied polyurethane composition is pressed onto a flange of the vehicle body and cured.

The first and/or second substrate may be subjected to pretreatment prior to application of the adhesive. Such pretreatment may be chemical, physical or physicochemical. Particularly suitable pretreatments include the roughening of the surface or the removal of contaminants by abrasion, brushing or wiping, in the form of a physical pretreatment. Chemical pretreatments include, for example, cleaning with solvent, etching, treatment with adhesion promoter solutions, primer compositions or cleaning products. Examples of the physicochemical pretreatment methods include plasma treatment, corona treatment, and plasma-gun treatment.

With particular preference the first and/or second substrate, at least in the bonding region, is pretreated, prior to the application of the polyurethane composition, with an adhesion promoter solution which comprises at least one alkoxysilane and/or at least one alkoxy titanate, preferably a mixture of an alkoxysilane and an alkoxy titanate, prior to bonding.

The polyurethane composition is produced and stored in particular in the absence of moisture. The polyurethane composition is stable on storage: that is, in suitable packaging or a suitable contrivance, such as in a drum, pouch or cartridge, for example, it can be kept typically for several months up to a year or more prior to its use without losing its usefulness.

The polyurethane composition of the invention is notable in particular for the combination of a rapid development of strength and good application capacity. In the context of the present invention it is possible to realize adhesives suitable for application not only cold but also warm or hot. In preferred embodiments of the invention the adhesives are distinguished by the combination of a rapid development of strength and good applicability both at high and at low temperatures.

This effect is particularly important in the temperature window between −10 and +35° C., in particular between 0 and 35° C., especially between 5° C. and 35° C. This is achieved by means of an adhesive which within this temperature range is notable for a comparably low viscosity increase and which even at low temperatures exhibits a sufficiently high reactivity.

It is not necessary for the adhesive—as in the case of reactive hotmelts, for example—to be heated first prior to application, or—as, for example, two-component polyurethane adhesives—to be mixed with a second component prior to application, in a complex operation. These advantages are particularly favorable in those cases where the adhesive is used for repair. Consequently, for example, it is possible to repair an automotive window on the street without the repairer having to have an oven in the service vehicle, let alone having to bring the defective vehicle to a garage where the necessary repair equipment is present. For the customer this brings the great advantage on the one hand that the costs of repair are less and on the other hand that he or she loses less time as a result of the repair, since the repair of the window can take place in situ, namely on the street. This advantage is particularly important in countries where the density of repair workshops is low. The removal of the need to mix in a second component brings advantages from the standpoints above all of logistics and processing reliability, since on the one hand it is not necessary to check whether the second component is in stock each time and on the other hand it is unnecessary to ensure painstakingly that the prescribed mixing ratio is observed. It is known, indeed, that with two-component polyurethanes a deviation from the mixing proportion by just a few percent is accompanied by massive changes in the product properties.

For applicability particularly important factors include the viscosity of the polyurethane composition and its temperature dependence. At the application temperature, in particular at 20° C., the polyurethane composition has a dynamic viscosity of preferably between 3500 and 15 000 Pas, in particular between 3500 and 10 000 Pas, preferably between 3500 and 6000 Pas.

In one particularly preferred embodiment the polyurethane composition has a ratio of the dynamic viscosities of the polyurethane composition at 5° C. and 35° C., η₅°/η₃₅°, of 1.5-4.5, in particular 2.0-3.5, and an green strength, measured at a measuring rate of 200 mm/min, at 5° C. and 80% relative humidity (r.h.) after 1 hour of greater than 10 N/cm², in particular of greater than 15 N/cm², preferably greater than 20 N/cm², more preferably greater than 40 N/cm².

For the green strength the high-speed strength in particular is of importance. This green strength, which is relevant for the characteristics in a crash situation, can be determined by means for example of impact pendulum tests. In this context the polyurethane compositions of the invention exhibit extremely good strength values, which typically—for a test speed of 1 m/s on the part of the pendulum—in any conditions from the relevant range of conditions, in particular in any of the conditions selected from the group of conditions comprising 5° C./80% r.h., 23° C./50% r.h., and 35° C./20% r.h., of more than 0.6 MPa, in particular more than 1 MPa. The 0.6 MPa can be considered here as a critical limit for endurance in a crash situation.

### EXAMPLES

### Production of the Polyurethane Compositions

Isocyanate-terminated prepolymers were prepared from 4,4′-MDI and the polyols indicated in Table 1, in the absence of moisture, in accordance with the method known to the skilled worker.

To produce the compositions indicated, all of the liquid components, apart from the catalysts, were introduced initially; optionally the melted polyester prepolymer, was added with stirring and in the absence of moisture, and the further constituents in accordance with Table 1 were added. After cooling, the homogeneously mixed compositions were dispensed into aluminum cartridges.

TABLE 1
Compositions.

| | | | | |
|---|---|---|---|---|
| Examples | 1 | 2 | Ref. 1 | Ref. 2 |

Polyurethane prepolymers A and D

| | | | | |
|---|---|---|---|---|
| Desmophen 5036 BT (Bayer AG) | 25.6 | 25.6 | 25.6 | 25.6 |
| [wt. %] | | | | |
| Acclaim ® 2220N (Bayer AG) [wt. %] | 5.47 | 5.47 | — | — |
| Acclaim ® 4200N (Bayer AG) [wt. %] | 6.22 | 4.8 | 13.07 | 13.07 |
| Dynacoll ® 7360 | | 1.2 | — | — |
| (Degussa AG) [wt. %] | | | | |
| 4,4′-MDI [wt. %] | 5.71 | 5.73 | 5.63 | 5.63 |
| Desmodur N3300 G [wt. %] | | 0.2 | | |
| DOA C [wt. %] | 11.6 | 7.9 | — | 19.4 |
| DIDP C′ [wt. %] | 8.92 | 8.74 | 19.4 | — |
| Carbon black [wt. %] | 20 | 28 | 20 | 20 |
| Kaolin [wt. %] | 16 | 12 | 16 | 16 |
| DBTL B2 [wt. %] | 0.2 | 0.15 | 0.3 | 0.3 |
| DMDEE/DMPEG* (3/4 = w/w) | 0.28 | 0.21 | — | — |
| B1 [wt. %] | | | | |

*DMPEG (dimorpholino-polyethylene glycol ether) according to EP 0 812 866 Al.

The reference adhesive Ref.1 contains no catalyst mixture B1/B2 and no compound of the formula C. The reference adhesive Ref.2 does contain a compound of the formulae C, in contrast to Ref.1, but likewise contains no catalyst mixture B1/B2. The reference adhesive Ref.3 is the commercial polyurethane adhesive SikaTack®Ultrafast (available commercially from Sika Schweiz AG), which features a non-inventive composition and represents one of the most rapid 1-component polyurethane systems on the market.

### Measurement Techniques

Viscosity:
The viscosity of the polyurethane composition was determined by means of the Physica MCR 300 rheomat from Paar Physica, in plate/plate mode, with a shear rate of 1 sec⁻¹ in the absence of moisture (nitrogen blanketing) at a temperature of 5° C., 23° C., and 35° C.

Green strength (FOG) 200 mm/min:
The green strength (FOG) was measured by means of a Zwick test instrument by end-face traction with a measuring speed of 200 mm/min after a cure time of 1 hour at 5° C./80 relative humidity, 23° C./50% relative humidity, and 35° C./20% relative humidity, respectively. The glass test elements (Rocholl Deutschland) were pretreated prior to bonding with Sika® activator (available commercially from Sika Schweiz AG).

Green strength (GS) 1 m/s:
The green strength (GS) was determined by means of an impact pendulum (pendulum length 75 cm, impact hammer weight 24 kg) after a cure time of 1 hour at 5° C./80% relative humidity, 23° C./50% relative humidity, and 35° C./20% relative humidity, respectively. The deflection was chosen such that the pendulum impinged at 1 m/s on one of the two adherends of the bonded specimen. In accordance with ISO 14343, the forces occurring on the other adherend were measured using a force transducer and recorded, and the green strength reported was determined from the maximum force.

### Results

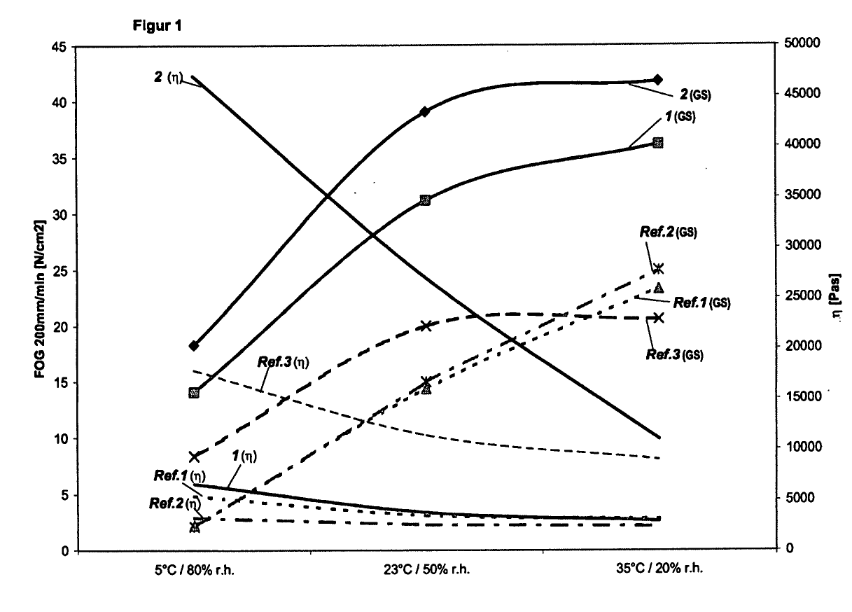

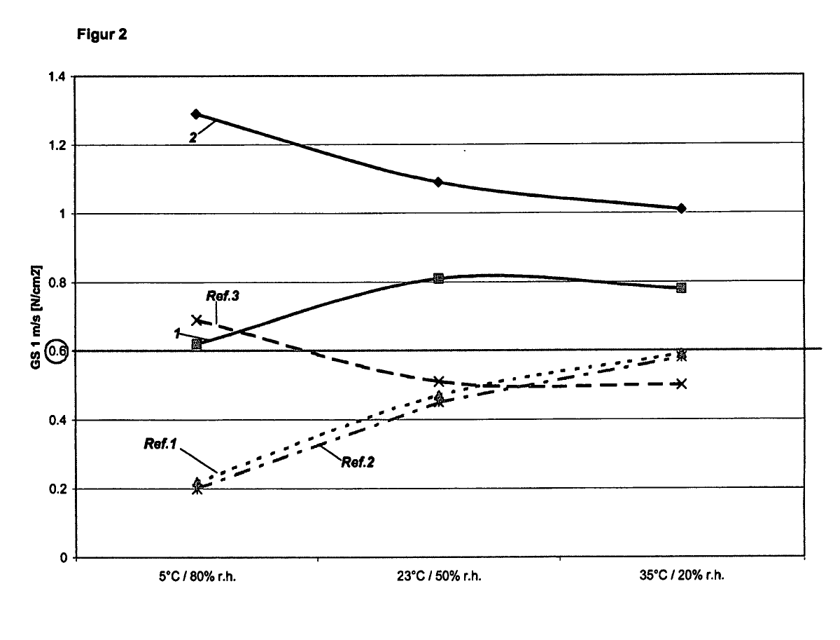

Table 2 and FIGS. 1 and 2 show the characteristics of the inventive adhesives 1 and 2 in contrast to the reference adhesives Ref.1, Ref.2, and Ref.3. Although the adhesives Ref.1 and Ref.2 do possess acceptable viscosity characteristics for cold application, the development of strength generally is too low. A comparison of reference adhesives Ref.1 and Ref.2 shows the advantageous effect of compound C. The use of the formula C very sharply lowers the ratio η₅°/η₃₅°. In contrast to the three reference adhesives Ref.1, Ref.2 and Ref.3, and in accordance with Table 2 and FIG. 2, at a high testing speed, which simulates the situation of a crash, the inventive adhesives 1 and 2 consistently give a value above 0.6 MPa over all temperature/climatic conditions ranges.

TABLE 2
Results

| | 1 | 2 | Ref.1 | Ref.2 | Ref.3 |
|---|---|---|---|---|---|
| Temperature of | 23 | 80 | 23 | 23 | 80 |
| adhesive on | | | | | |
| application [° C.] | | | | | |
| Green | | | | | |
| strength (FOG) | | | | | |
| 200 mm/min | | | | | |
| [N/cm²] | | | | | |
| 1 h 5° C./80% rel. | 14.1 | 18.3 | 2.2 | 2.1 | 8.4 |
| humidity | | | | | |
| 1 h 23° C./50% rel. | 31.2 | 39.1 | 14.4 | 15.0 | 20 |
| humidity | | | | | |
| 1 h 35° C./20% rel. | 36.2 | 41.8 | 23.3 | 25 | 20.6 |
| humidity | | | | | |
| Green strength | | | | | |
| (GS) 1 m/s (MPa) | | | | | |
| 1 h 5° C./80% rel. | 0.62 | 1.29 | 0.22 | 0.2 | 0.69 |
| humidity | | | | | |
| 1 h 23° C./50% rel. | 0.81 | 1.09 | 0.47 | 0.45 | 0.51 |
| humidity | | | | | |
| 1 h 35° C./20% rel. | 0.78 | 1.01 | 0.59 | 0.58 | 0.50 |
| humidity | | | | | |
| Viscosity (η) [Pas] | | | | | |
| 5° C. | 6600 | 47 000 | 5400 | 3210 | 17 800 |
| 20° C. | 3780 | 27 000 | 3460 | 2530 | 11 400 |
| 35° C. | 2910 | 11 000 | 3120 | 2370 | 9000 |
| η_{5°}/η_{35°} | 2.27 | 4.27 | 1.73 | 1.35 | 1.98 |

Adhesive 1 is an adhesive suitable for cold application which has an excellent viscosity over the entire temperature range. Moreover, it possesses very rapid development of strength and increased crash resistance.

Adhesive 2, as compared with adhesive 1, represents an example of an adhesive which is applied warm, that exhibits excellent development of strength and crash characteristics.

1. A polyurethane composition comprising
at least one polyurethane prepolymer A containing isocyanate end groups, prepared from at least one aromatic polyisocyanate and at least one polyoxyalkylene polyol A1;
at least one catalyst B1 containing at least one tertiary amine group;
at least one tin catalyst B2;
5% to 40% by weight of carbon black, based on the weight of the polyurethane composition;
at least one compound C of the formula (I) 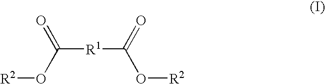
where R¹ is a C₃-C₈ alkylene group
and R² is a C₇-C₁₃ alkyl group which is optionally branched;
0% to 4% by weight of a polyurethane prepolymer D containing isocyanate end groups, prepared from at least one polyisocyanate and at least one polyester polyol, based on the weight of the polyurethane composition;
0% to 20% by weight of a polyurethane prepolymer E containing isocyanate end groups, prepared from at least one polyisocyanate and at least one polycarbonate polyol, based on the weight of the polyurethane composition;
0% to 15% by weight of a polyurethane prepolymer F containing isocyanate end groups, prepared from at least one aliphatic polyisocyanate and at least one polyoxyalkylene polyol F1;
0% to 4% by weight of an aliphatic polyisocyanate G, based on the weight of the polyurethane composition;
0% to 4% by weight of a pyrogenic silica.

2. The polyurethane composition of claim 1, characterized in that the polyurethane composition is one-component and moisture-curing.

3. The polyurethane composition of claim 1, characterized in that the polyoxyalkylene polyol A1 and optionally the polyoxyalkylene polyol F1 is a polyoxyethylene polyol or a poly(oxyethylene/oxypropylene) polyol, in particular a polyethylene glycol.

4. The polyurethane composition of claim 3, characterized in that the polyoxyalkylene polyol is poly(oxyethylene/oxypropylene) polyol having an EO/PO ratio of more than 10 mol/90 mol, preferably of between 10 mol/190 mol and 35 mol/65 mol.

5. The polyurethane composition of claim 1, characterized in that the polyoxyalkylene polyol F1 is a polyoxypropylene polyol.

6. The polyurethane composition of claim 1, characterized in that the polyisocyanate for preparing the polyurethane prepolymer A and optionally D and optionally E, independently of one another, is an aromatic polyisocyanate selected from the group comprising tolylene 2,4- and 2,6-diisocyanate (TDI) and any desired mixtures of these isomers, diphenylmethane 4,4′-diisocyanate (MDI) and mixtures thereof and also all of their isomers and oligomers.

7. The polyurethane composition of claim 1, characterized in that the catalyst B1 is 1,4-diazabicyclo[2.2.2]octane (DABCO) or a dimorpholino ether, especially 2,2′-dimorpholinodiethyl ether (DMDEE).

8. The polyurethane composition of claim 1, characterized in that the tin catalyst B2 is selected from the group of tin compounds comprising dibutyltin diacetate, dibutyltin dilaurate, dioctyltin dicarboxylate, dibutyltin dichloride or mixtures thereof.

9. The polyurethane composition of claim 1, characterized in that the compound C is a dialkyl adipate, especially dioctyl adipate.

10. The polyurethane composition of claim 1, characterized in that the polyurethane composition further comprises at least one compound C′ of the formula (I′) 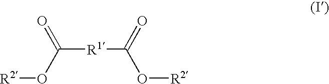
where R^{1′} is an optionally substituted phenylene group
and R^{2′} is a C₇-C₁₃ alkyl group which is optionally branched.

11. The polyurethane composition of claim 10, characterized in that compound C′ is a dialkyl phthalate, especially diisodecyl phthalate.

12. The polyurethane composition of claim 1, characterized in that the polyester polyol of the polyurethane prepolymer D is prepared from a diol, in particular from an alkylenediol, preferably hexanediol, and a dicarboxylic acid, especially adipic acid, or is a polyester polyol prepared from lactones, especially caprolactone.

13. The polyurethane composition of claim 1, characterized in that the polyisocyanate for preparing the polyurethane prepolymer F and optionally D and optionally E is an aliphatic polyisocyanate selected from the group comprising hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and 1,4-diisocyanate and any desired mixtures of these isomers, 1-isocyanato-3,3,5-trimethyl-5-isocyanatomethylcyclohexane (i.e., isophorone diisocyanate or IPDI), perhydrodiphenylmethane 2,4′- and 4,4′-diisocyanate (HMDI), 1,4-diisocyanato-2,2,6-trimethylcyclohexane (TMCDI), and also oligomers and polymers of the aforementioned isocyanates, and also any desired mixtures of the aforementioned isocyanates.

14. The polyurethane composition of claim 1, characterized in that the fraction of the polyurethane prepolymer D is 1% to 4% by weight, based on the weight of the polyurethane composition.

15. The polyurethane composition of claim 1, characterized in that the aliphatic polyisocyanate G is an aliphatic isocyanurate bearing NCO groups and/or an aliphatic biuret bearing NCO groups, in particular an isophorone diisocyanate (IPDI) isocyanurate and/or a hexamethylene 1,6-diisocyanate (HDI) biuret.

16. The polyurethane composition of claim 1, characterized in that the fraction of the aliphatic polyisocyanate G is 0.2% to 4% by weight, based on the weight of the polyurethane composition.

17. The polyurethane composition of claim 1, characterized in that the ratio of the dynamic viscosities of the polyurethane composition at 5° C. and 35° C., η₅°/η₃₅°, is 1.5-4.5, especially 2.0-3.5, and the green strength of the polyurethane composition at a measurement rate of 200 mm/min at 5° C. and 80% relative humidity after 1 hour is greater than 10 N/cm², in particular greater than 15 N/cm², preferably greater than 20 N/cm², more preferably greater than 40 N/cm².

18. The polyurethane composition of claim 1, characterized in that the dynamic viscosity of the polyurethane composition at the application temperature, in particular at 20° C., is between 3500 and 15 000 Pas, in particular between 3500 and 10 000 Pas, preferably between 3500 and 6000 Pas.

19. The polyurethane composition of claim 1, characterized in that the polyurethane composition after 60 minutes has an green strength of more than 0.6 MPa, in particular of more than 1 MPa, measured using an impact pendulum at a measurement rate of 1 m/s, under any of the conditions selected from the group of conditions comprising 5° C./80% r.h., 23° C./50% r.h., and 35° C./20% r.h.

20. The use of the polyurethane composition of claim 1, as an adhesive or sealant, in particular as an automotive window adhesive.

21. A method of adhesively bonding vehicle windows, comprising the steps of
applying the polyurethane composition of claim 1 to the surface of a first substrate,
contacting the polyurethane composition with a surface of a second substrate,
curing the polyurethane composition.

22. The method of claim 21, characterized in that the first or the second substrate is made of a material selected from the group comprising glass, glass ceramic, paint, steel, aluminum, polycarbonate, ABS, GRP, and polypropylene.

23. The method of claim 21, characterized in that the first and/or second substrate, prior to adhesive bonding, has been subjected to a chemical, physical or physicochemical pretreatment.

24. The method of claim 21, characterized in that the first substrate is a vehicle window, in particular an automotive window.

25. The method of claim 24, characterized in that the window, prior to the application of the polyurethane composition, has been treated at least in the bonding area with an adhesion promoter solution which comprises at least one alkoxysilane and/or at least one alkoxytitanate, preferably a mixture of an alkoxysilane and an alkoxytitanate.
